(19) United States
(12) Patent Application Publication
(10) Pub. No.: US 2008/0268900 A1
(43) Pub. Date: Oct. 30, 2008

(54) Mobile Terminal Which Enables Image Projection

(76) Inventor: Jeong Hyun Lee, Gyeonggi-do (KR)

Correspondence Address: HYUN JONG PARK, 41 WHITE BIRCH ROAD, REDDING, CT, 06896-2209, US

(21) Appl. No.: 11/996,493

(22) PCT Filed: Jul. 10, 2006
(86) PCT No.: PCT/KR2006/002698

§ 371 Date: Jun. 12, 2008

(30) Foreign Application Priority Data
Jul. 22, 2005 (KR) 10-2005-0066603

(51) Int. Cl. H04M 1/00

(52) U.S. Cl. 455/556.1

(57) ABSTRACT

Disclosed herein is a mobile terminal having an image projection function. The mobile terminal includes a camera module, a projection type display device, a light source module, and a control unit. The camera module includes a camera lens and an image detection device. The projection type display device displays images. The light source module includes a light emission device for emitting light having a predetermined brightness. The control unit performs control so that the light source module is operated, thus, the images are projected through the camera lens of the camera module.

### REFERENCE TO RELATED APPLICATIONS

This is a U.S. national phase application of pending International Patent Application PCT/KR2006/002698 filed on Jul. 10, 2006, which designates the United States and claims priority of Korean Patent Application No. 10-2005-0066603 filed on Jul. 22, 2005.

### FIELD OF THE INVENTION

The present invention relates, in general, to a mobile terminal having an image projection function and, more particularly, to a mobile terminal having an image projection function, which projects image information, generally displayed on the screen of a mobile terminal, onto a screen, such as a wall or paper, instead of the monitor screen of the mobile terminal, so that a user can view the projected image information.

### BACKGROUND OF THE INVENTION

A conventional mobile terminal, such as a mobile phone or a Personal Digital Assistant (PDA), displays an image on a small-sized monitor screen. Generally, the mobile terminal chiefly uses a Liquid Crystal Display (LCD) or organic EletroLuminescence device (OELD) as a monitor screen. However, the display method is inconvenient because the size of the screen is insufficiently small. Accordingly, in order to increase user satisfaction when playing games or viewing satellite Digital Multimedia Broadcasting (DMB), it is necessary to provide a screen having a sufficient size.

Conventional attempts to provide an image projection function to a mobile terminal and, thereby, enable a user to enjoy a screen having a relatively large size, include technologies proposed in Korean utility Model Registration No. 20-263336 and Korean Unexamined Patent Publication No. 10-2005-62086.

Korean Utility Model Registration No. 20-263336, illustrated in FIG. 1, disclosed an image mobile phone device that is provided in a set with a liquid crystal projector. The image mobile phone device includes a liquid crystal projector 46, thus providing a large-sized image using a wall or the ground as a screen.

Furthermore, Korean Unexamined Patent Publication No. 10-2005-62086, illustrated in FIG. 2, proposed a projection image processing system for a mobile communication terminal. The projection image processing system includes memory 120 for storing images or image data, a projector module 210 for processing the images or image data stored in memory 120 and outputting projection images through a lens, and a projector control module 111 for performing control so that the images or image data stored the memory are read and output as projected images through the projector module 210, the projector control module 111 being embodied in the form of software to be executed by the control unit (MSM) of the mobile communication terminal 100.

However, the conventional technologies merely proposed an idea in which a module having an image projection function, that is, the above-described liquid crystal projector unit or projector module, is included in a mobile communication terminal, but have a limitation in that they do not provide an actual solution about how to mount the image projection module.

Particularly, in the case where the image projection module is included in the mobile communication terminal, the problem of increased size of the mobile communication terminal must be overcome. Furthermore, an improved device, having a structure in which the problems of heat dissipation and cooling of a device are taken into account for the case where the projector module consumes a large amount of power and the feasibility of implementation is high, is required.

### SUMMARY OF THE INVENTION

Accordingly, the present invention has been made keeping in mind the above problems occurring in the prior art, and an object of the present invention is to provide a mobile terminal having an image projection function, which enables the further reduction of device size by using the optical system of a camera provided in the mobile device.

Another object of the present invention is to provide a mobile terminal having an image projection function, which enables the further reduction of the device size by effectively using a light source provided in the mobile device.

A further object of the present invention is to provide a mobile terminal having an image projection function, which can effectively dissipate heat generated by the light source and solve the problems of heat dissipation and cooling of elements, by using a cooling Printed Circuit Board (PCB).

Yet another object of the present invention is to provide a mobile terminal having an image projection function, which can be used as a portable projector by processing image data received from an external device and projecting images.

In order to accomplish the above objects, the present invention provides a mobile terminal having an image projection function, including a camera module comprising a camera lens and an image detection device; a projection type display device for displaying images; a light source module comprising a light emission device for emitting light having a predetermined brightness; and a control unit for performing control so that the light source module is operated, thus, the images are projected through the camera lens of the camera module.

It is preferred that the mobile terminal further include a first path control unit for performing control so that light incident on the lens is transferred to the image detection device, or light having passed through the projection type display device is transferred to the camera lens, under the control of the control unit.

Furthermore, it is preferred that the mobile terminal further include a second path control unit for controlling a light path so that the light emitted by the light source module is emitted outside the device at a time of image capture through the camera module, and the light passes through the projection type display device at a time of image projection through the projection type display device.

If needed, the mobile terminal may further include a heat dissipation panel for transferring heat, which is generated by the light source module, to a low-temperature portion.

The heat dissipation panel includes a PCB body, provided with a conductive wiring pattern for wiring electronic components, which is formed on at least a region of an outer surface of the body, and an encapsulated inner space, and configured such that coolant undergoing phase variation due to heat generated by the electronic components is injected into the inner space; at least one wick structure configured to be inserted into the inner space of the PCB body, configured to come into contact with the inner surface of an upper plate opposite a region where at least some of the electronic components are disposed thereon, and configured to have minute channels that keep the coolant therein and provide paths for movement of the coolant in a direction parallel to the inner surface of the upper plate using capillary force; and at least one support structure configured to perform support so that the wick structure comes into contact with the inner surface of the upper plate opposite a region where at least some of the electronic components are disposed thereon, and configured to have a plurality of through holes for providing paths for the movement of the coolant and vapor; wherein the coolant occupies at least a portion of the inner space of the PCB body, moves across the wick structure using capillary force generated in the minute channels of the wick structure, is evaporated, moved, and condensed by heat generated by the electronic components, and circulates in the inner space, thus performing heat transfer.

Furthermore, if needed, the mobile terminal may further include an interface unit for receiving an image signal received from an external image data processing device, and enabling the projection of the received image signal.

Furthermore, if needed, the mobile terminal may further include a power connection unit for supplying power of a power source provided outside a device.

In addition, the present invention provides a mobile terminal having an image projection function, including a camera module comprising a light source module for subject illumination, a camera lens, and an image detection device; a projection type display device for displaying images; a projection lens for adjusting the focal distance of light passing through the projection type display device; and a control unit for performing control so that light emitted by the light source module for subject illumination passes through the projection type display device, and the images from the projection type display device are projected through the projection lens.

In addition, the present invention provides a mobile terminal having an image projection function, including a first mode for capturing an image by operating a camera module, the camera module comprising a camera lens and an image detection device; and a second mode for projecting the image through the camera lens of the camera module by operating a light source module, which comprises a light emission device for emitting light having a predetermined brightness and a projection type display device for displaying image data.

In addition, the present invention provides a mobile terminal having an image projection function, including a first mode for capturing an image by operating a camera module, the camera module including a light source module for subject illumination, a camera lens and an image detection device; and a second mode for performing control so that light emitted by the light source module for subject illumination passes through a projection type display device, and an image from the projection type display device for displaying image data is projected through a projection lens for adjusting the focal distance of the light.

In the present invention, a User Interface (UI) unit for providing a selection menu so that a user selects any of the first and second modes may be further included.

According to the present invention, the mobile terminal having an image projection function enables the further reduction of device size by using the optical system of a camera provided in a mobile device.

Furthermore, the mobile terminal having an image projection function enables the further reduction of the size of the mobile device by effectively using a light source provided in the mobile device.

Furthermore, the mobile terminal having an image projection function can effectively dissipate heat generated by the light source and solve problems of heat dissipation and cooling of elements using a cooling PCB.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing the construction of a conventional image mobile phone device that is provided with a set with a liquid crystal projector;

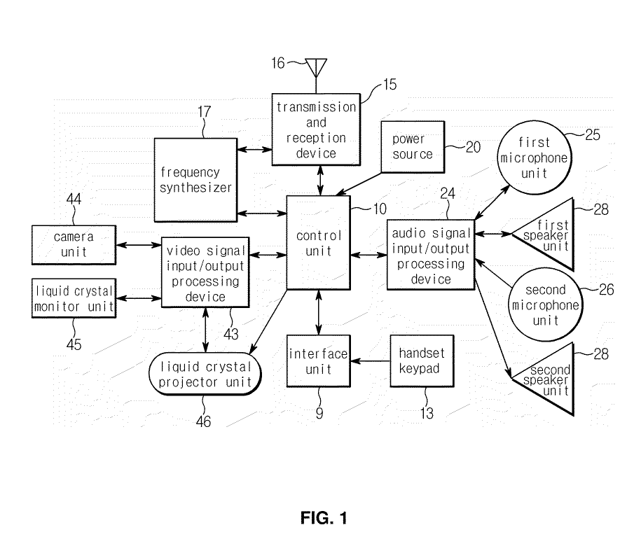

FIG. 2 is a block diagram showing the construction of a conventional projection image processing system for a mobile communication terminal;

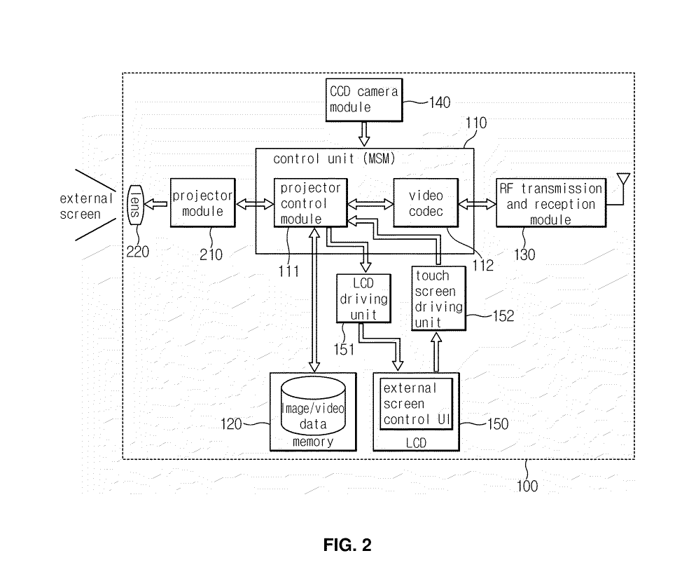

FIG. 3 is a block diagram schematically showing the construction of a mobile terminal having an image projection function according to a preferred embodiment of the present invention;

FIG. 4 is an example of projecting an image using the mobile terminal having an image projection function of the present invention;

FIG. 5 is another example of projecting an image using the mobile terminal having an image projection function of the present invention;

FIG. 6 is a diagram showing an example of projecting video data received from an external device using the mobile terminal having an image projection function of the present invention;

FIGS. 7 and 8 are diagrams schematically showing examples of the construction of a heat dissipation PCB; and

FIG. 9 is a diagram showing an example in which the structure of the heat dissipation panel described above is applied to the structure of the heat sink of a semiconductor package for a white Light Emitting Diode (LED).

### DETAILED DESCRIPTION OF THE INVENTION

A preferred embodiment of the present invention is described in detail with reference to the accompanying drawings below.

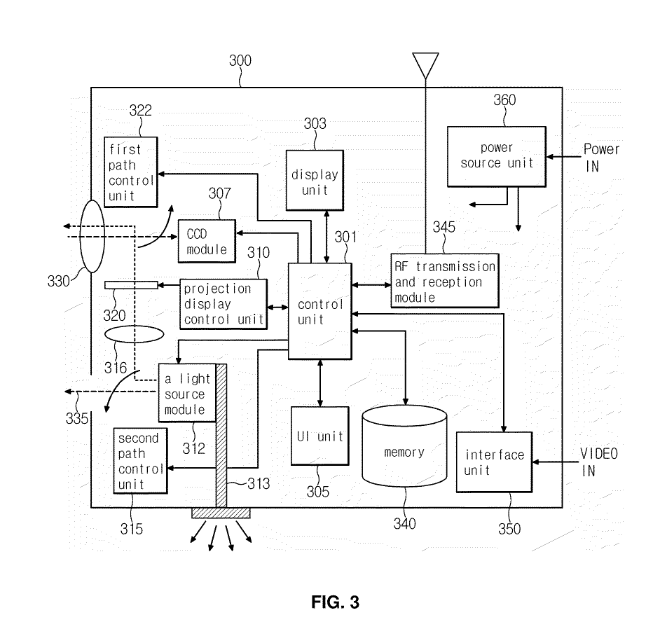

FIG. 3 is a block diagram schematically showing the construction of a mobile terminal having an image projection function according to a preferred embodiment of the present invention.

As shown in FIG. 3, the mobile terminal includes a control unit 301, a display unit 303, a UI unit 305, a Charge Coupled Device (CCD) module 307, a projection display control unit 310, a projection display device 320, a light source module 312, a heat dissipation panel 313, a first path control unit 322, a second path control unit 314, a camera lens 330, a light emission opening 335, a second lens 316, memory 340, a Radio Frequency (RF) transmission and reception module 345, and an interface unit 350.

Since the image display unit 303 such as a monitor, the UI unit 305a including a keypad, the RF transmission and reception module 345, and the memory 340, which are provided to perform the basic functions of the mobile terminal, are almost the same as those of a typical mobile terminal, detailed descriptions thereof are omitted.

The camera lens 330 and the CCD module 307 constitute a camera module installed in a mobile device, such as a typical mobile phone. In this case, as an image detection device, any image detection device, such as a CMOS image sensor, as well as the CCD module 307 may be used.

Furthermore, in a digital camera module to be installed in a mobile device, the light source module 312, including a white LED, is generally provided to facilitate image capture in a dark place. A method of performing scanning using a single color LED beside the white LED or using a light source, such as a semiconductor laser, may be conducted.

An LCD, a Digital Light Processor (DLP) or the like may be used as the projection display device 320. The DLP refers to a projection display device that adopts a Digital Micromirror Device (DMD), on the surface of which the smallest mirrors are disposed, as a display device.

The mobile terminal 300 has a first mode for capturing a subject using the camera module, and a second mode for projecting an image using the projection display device. A user can switch between the first and second modes by making selections from a menu provided through the UI unit 305.

In particular, the mobile terminal 300 is constructed to perform both the display and projection of an image through the camera lens 330. From such a construction, the image projection function may be implemented using a reduced number of elements in the mobile terminal 300, thus preventing an increase in the device size.

In image projection mode, the control unit 301 controls the projection display control unit 310 such that image data is displayed on the projection display device 320. Light emitted by the light source module 312 is transferred to the projection display device 320 using the second path control unit 314. In this case, the optical means, that is, the lens 316, is additionally provided such that the light emitted by the light source module is effectively transferred. An optical path through which the light emitted by the light source module is transmitted may be constructed using combinations of a plurality of optical means, such as optical fibers and light guides, which are well known.

The second path control unit 314 functions to switch a light path so that the light, which is emitted by the light source module 312, can be emitted through the light emission opening 335 outside the terminal in capture mode in which a camera is used, can be transferred to the projection display device 320 in image projection mode.

Furthermore, the first path control unit 322 functions to enable light, which is incident from a subject, to be oriented toward the image detection device, that is, the CCD module 307, in capture mode in which a camera is used, and to enable light, which passes through the projection display device 320, to be emitted through the camera lens 330 outside the terminal in image projection mode.

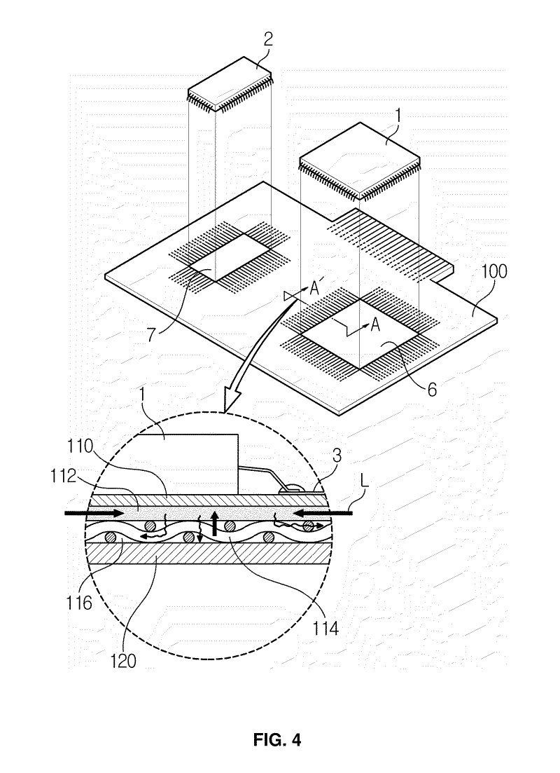

If needed, the heat dissipation panel 313 may be provided in the light source module or on a substrate on which elements are mounted. The heat dissipation panel 313 is connected to the outside of the device and functions to dissipate heat, which is generated by the device, to the outside. For the heat dissipation panel, a heat pipe or a heat dissipation PCB may be used. The term “heat dissipation PCB” specifically refers to a device having the structure shown in FIG. 4.

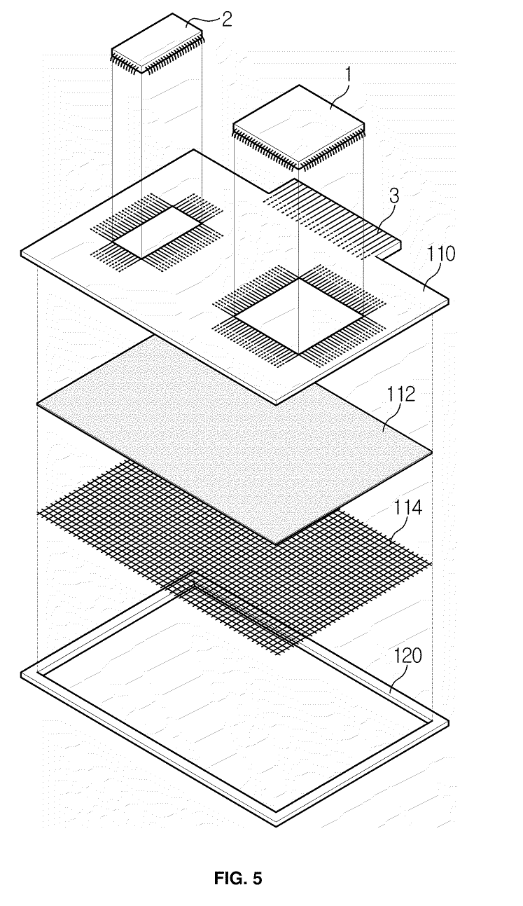

FIGS. 4 and 5 are diagrams schematically showing examples of the construction of a heat dissipation PCB. The heat dissipation PCB may be manufactured to have various shapes and dimensions according to the type, characteristic and design of circuitry to be mounted thereon, and the type and design of an electronic device on which the PCB is to be mounted. Generally, various types of heat dissipation electronic components, such as Integrated Circuits (ICs) 1 and 2, are mounted on the PCB as shown in FIGS. 4 and 5. If needed, a connection terminal unit may be appropriately arranged such that the PCB can be installed in the slot of a computer. A predetermined conductive wiring pattern 3 is formed on the surface of the PCB body 100. Various patterns may be implemented according to the details of a circuit design. The conductive wiring pattern may be formed only on the upper surface of the PCB body 100, or on both the upper and lower surfaces of the PCB body 100. Furthermore, a plurality of layers may be stacked in the PCB body 100 (multilayer PCB).

In this case, as shown in the partial section of FIG. 4, a heat transfer structure is provided in the PCB body 100. For this purpose, a predetermined inner space 116 is formed in the PCB body 100. It is preferred that the inner space 116 be isolated from outside air, and be maintained at a pressure lower than atmospheric pressure to promote the evaporation of coolant. The thickness of an upper plate 110 constituting the inner surface of the inner space 116 must be appropriately determined in consideration of insulation, mechanical strength, and the efficient transfer of heat generated by the electronic component 1 mounted on the outer surface of the upper plate 110. In the case where the upper plate 110 is made of synthetic resins, it is preferred that the thickness thereof be less than 2 mm to realize a desired heat transfer characteristic.

In order to facilitate the formation of the inner space 116 and the assembly of components inserted thereinto, the PCB body 100 may be constructed by combining the upper plate 110 and the lower plate 120. A wick structure 112, which can keep coolant using the plurality of minute channels formed therein and can continuously supply the coolant by moving it in a direction L toward a heat source using capillary force, is provided on the inner surface of the upper plate 110 in the inner space 116.

The wick structure 112 must come into close contact with the inner surface of the upper plate 110 in order to attain a desired cooling effect. Furthermore, a path V for the movement of coolant, which is restored to a liquid state in the inner space 116 after evaporation and condensation, must be appropriately formed such that vapor evaporated by the heat source can move uninterruptedly. Accordingly, the support structure 114, having a plurality of through holes, is installed in the inner space 116 of the PCB body 100 in order to enable the wick structure 112 to come into close contact with the inner surface of the upper plate 110 and, at the same time, provide paths for the movement of vapor-state coolant, which is evaporated, and coolant, which is condensed by a low-temperature unit. In the structure of FIG. 4, a screen mesh is used for the support structure 114, but the present invention is not limited thereto, and thus may employ various support structures.

As shown in the partial section of FIG. 4, coolant is supplied in the direction L of the heat source due to the capillary force generated in the minute channels of the wick structure 112, is evaporated near the heat source, and moves through the through holes, which are formed in the support structure 114, to the low-temperature unit in a vapor state. Thereafter, the vapor-state coolant is condensed again in a liquid state by the low-temperature unit and is circulated through the wick structure 112. Accordingly, the heat transfer structure, which is formed in the PCB body 100 of the present invention, dissipates heat merely by circulating the coolant without requiring a separate heat exchange device. The PCB body 100, which provides the upper plate 110, the lower plate 120, the wick structure 112 and the support structure 114 therein, may be formed to be very thin. When the structure of the present invention is adopted, the PCB body 100 may be formed to have a total thickness of less than 5 mm (preferably, less than 2 mm), so that a high cooling efficiency can be achieved without increasing the thickness thereof compared to a conventional PCB substrate, in which no such heat transfer structure is provided.

Furthermore, when the heat dissipation PCB is used, the PCB itself is a kind of heat sink, so that it is not necessary to separately attach a structure, such as a heat sink, to the electronic component, such as the IC 1, which is mounted on the PCB of the present invention. Accordingly, as a result thereof, the overall size of the PCB on which the electronic component is mounted can be reduced. If needed, heat-conductive paste or adhesive may be applied such that heat transfer is made more efficient by improving the contact between the electronic component, such as the IC 1, and the PCB.

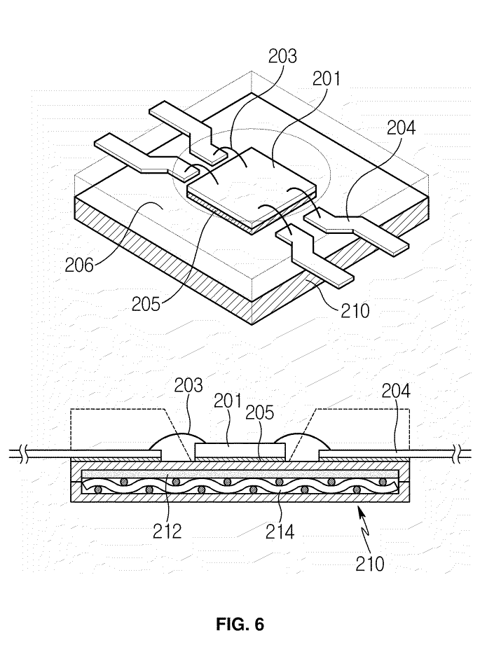

FIG. 6 is a diagram showing an example in which the structure of the heat dissipation panel described above is applied to the structure of the heat sink of a semiconductor package for a white LED. The package structure is a typical structure in which a semiconductor chip 201 is mounted on a heat sink 210 via a bonding layer 205, and is connected to lead terminals 204 using wires 203. A fluorescent material dispersed resin molding layer 206 may be provided to encapsulate the wires 203, a part of a lead frame 204 and the semiconductor chip 201, and converts light, which is emitted by the semiconductor chip 201, into light having a different wavelength. In this case, as shown in FIG. 6, the heat sink 210 is a portion of the entire package, and a wick structure 212 and a support structure 214 exist inside the heat sink 210. The operation of circulating coolant using the wick structure 212 and support structure 214 of the heat sink 210 is performed in the same manner as the above-described operation.

Furthermore, the mobile terminal 300 may further include an interface unit 350 for receiving a video data input signal, output from an external image processing device, such as a PC or a display device. The video data input signal, input through the interface unit 350, is processed by the control unit 301 of the device, and is transferred to the projection display control unit 310. In this case, the mobile terminal 300 functions as a portable general-purpose image projector, thus enabling the projection of images input through various external devices.

Although a power unit 360 for supplying power to the individual units of the device may employ a battery, as in other mobile devices, it is preferred that the power unit 360 be constructed to be directly connected to an external power source because continuous supply power may be required to project images.

The embodiment for the construction of the mobile terminal 300 having an image projection function is only an example used to describe the present invention, and various modifications may be made. For example, the camera lens 330 may be used for both capturing and projecting. In this case, light source modules for the respective functions may be separately provided. Alternatively, capturing and projecting may be performed using a single light source module and separate lenses.

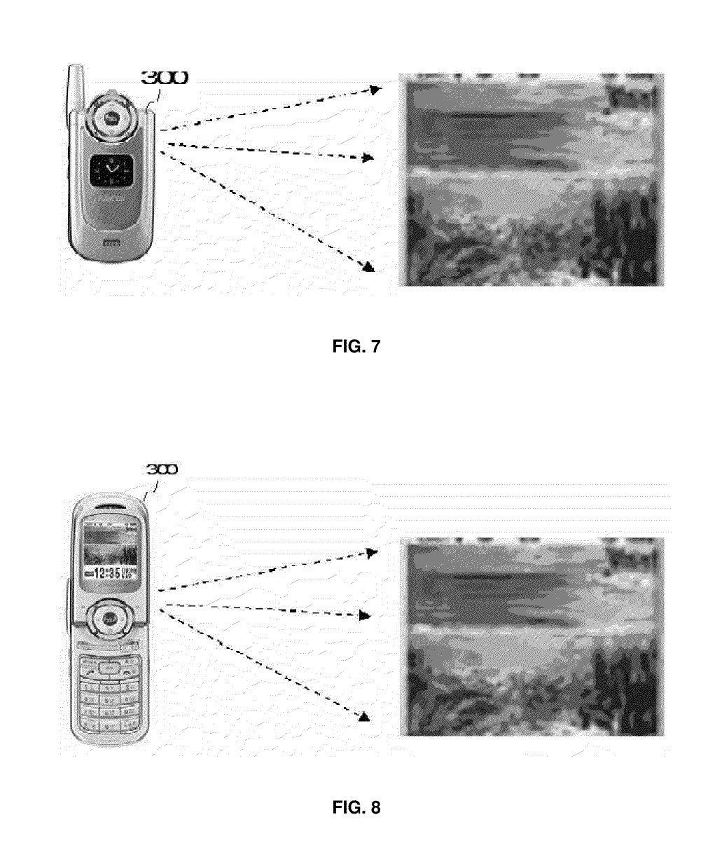

FIG. 7 is a diagram showing an example of projecting an image using the mobile terminal having an image projection function according to the present invention. As shown in FIG. 7, the mobile terminal 300 may be configured to perform an image projection function regardless of the operation of the display unit 303, such as the monitor of the mobile terminal 300. In this case, an image may be projected without the cover of the terminal being opened.

FIG. 8 is a diagram showing another example of projecting an image using the mobile terminal having an image projection function according to the present invention. As shown in FIG. 8, the mobile terminal 300 may be configured to display an image on the screen of the mobile terminal 300 and, at the same time, perform the image projection function.

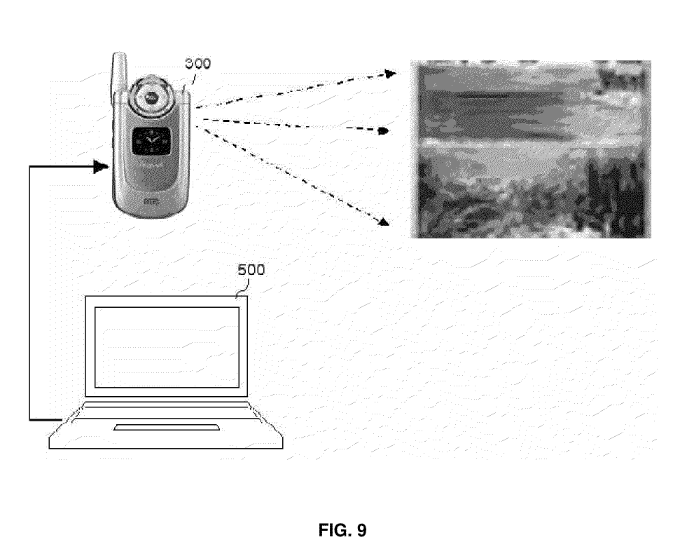

FIG. 9 is a diagram showing an example of projecting video data received from an external device using the mobile terminal having an image projection function of the present invention. As shown in FIG. 9, the mobile terminal 300 may be configured to project image data provided by a notebook computer 500, a pc, or some other display device, so that it can be used as a portable image projector for various purposes.

According to the present invention, the mobile terminal having an image projection function enables the further reduction of device size by using the optical system of a camera provided in a mobile device.

Furthermore, the mobile terminal having an image projection function enables the further reduction of the size of the mobile device by effectively using a light source provided in the mobile device.

Furthermore, the mobile terminal having an image projection function can effectively dissipate heat generated by the light source and solve problems of heat dissipation and cooling of elements using a cooling PCB.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

1. A mobile terminal having an image projection function, comprising:
a camera module comprising a camera lens and an image detection device;
a projection type display device for displaying images;
a light source module comprising a light emission device for emitting light having a predetermined brightness; and
a control unit for performing control so that the light source module is operated, thus, the images are projected through the camera lens of the camera module.

2. The mobile terminal according to claim 1, further comprising a first path control unit for performing control so that light incident on the lens is transferred to the image detection device, or light having passed through the projection type display device is transferred to the camera lens, under control of the control unit.

3. The mobile terminal according to claim 1, further comprising a second path control unit for controlling a light path so that the light emitted by the light source module is emitted outside the device at a time of image capture through the camera module, and the light passes through the projection type display device at a time of image projection through the projection type display device.

4. The mobile terminal according to claim 1, further comprising a heat dissipation panel for transferring heat, which is generated by the light source module, to a low-temperature portion.

5. The mobile terminal according to claim 4, wherein the heat dissipation panel comprises:
a Printed Circuit Board (PCB) body, provided with a conductive wiring pattern for wiring electronic components, which is formed on at least a region of an outer surface of the body, and an encapsulated inner space, and configured such that coolant undergoing phase variation due to heat generated by the electronic components is injected into the inner space;
at least one wick structure configured to be inserted into the inner space of the PCB body, configured to come into contact with an inner surface of an upper plate opposite a region where at least some of the electronic components are disposed thereon, and configured to have minute channels that keep the coolant therein and provide paths for movement of the coolant in a direction parallel to the inner surface of the upper plate using capillary force; and
at least one support structure configured to perform support so that the wick structure comes into contact with the inner surface of the upper plate opposite a region where at least some of the electronic components are disposed thereon, and configured to have a plurality of through holes for providing paths for movement of the coolant and vapor;
wherein the coolant occupies at least a portion of the inner space of the PCB body, moves across the wick structure using capillary force generated in the minute channels of the wick structure, is evaporated, moved, and condensed by heat generated by the electronic components, and circulates in the inner space, thus performing heat transfer.

6. The mobile terminal according to claim 1, further comprising an interface unit for receiving an image signal received from an external image data processing device, and enabling projection of the received image signal.

7. The mobile terminal according to claim 1, further comprising a power connection unit for supplying power of a power source provided outside a device.

8. A mobile terminal having an image projection function, comprising:
a camera module comprising a light source module for subject illumination, a camera lens, and an image detection device;
a projection type display device for displaying images;
a projection lens for adjusting a focal distance of light passing through the projection type display device; and
a control unit for performing control so that light emitted by the light source module for subject illumination passes through the projection type display device, and the images from the projection type display device are projected through the projection lens.

9. A mobile terminal having an image projection function, comprising:
a first mode for capturing an image by operating a camera module, the camera module comprising a camera lens and an image detection device; and
a second mode for projecting the image through the camera lens of the camera module by operating a light source module, which comprises a light emission device for emitting light having a predetermined brightness and a projection type display device for displaying image data.

10. A mobile terminal having an image projection function, comprising:
a first mode for capturing an image by operating a camera module, the camera module comprising a light source module for subject illumination, a camera lens and an image detection device; and
a second mode for performing control so that light emitted by the light source module for subject illumination passes through a projection type display device, and an image from the projection type display device for displaying image data is projected through a projection lens for adjusting a focal distance of the light.

11. The mobile terminal according to claim 9, further comprising a User Interface (UI) unit for providing a selection menu so that a user selects any of the first and second modes.

12. The mobile terminal according to claim 10, further comprising a User Interface (UI) unit for providing a selection menu so that a user selects any of the first and second modes.
